(19) United States
(12) Patent Application Publication
(10) Pub. No.: US 2008/0162454 A1
(43) Pub. Date: Jul. 3, 2008

(54) METHOD AND APPARATUS FOR KEYWORD-BASED MEDIA ITEM TRANSMISSION

(75) Inventors: Louis J. Lundell, Buffalo Grove, IL (US); Yan Ming Cheng, Inverness, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/619,465

(22) Filed: Jan. 3, 2007

(51) Int. Cl. G06F 17/30; G10L 15/00; G06F 17/27

(52) U.S. Cl. 707/5; 704/251; 704/9; 704/E15.001; 707/E17.101

(57) ABSTRACT

A system includes a first communications device [105] to participate in a conversation with at least a second communication device [110]. An intelligent communication agent [120] monitors the conversation for at least one keyword. In response to detecting the at least one keyword, the intelligent communication agent performs a search for multimedia content corresponding to the at least one keyword and retrieves the multimedia content. A logic engine [135] determines relevant content of the multimedia content based on at least one of a conversation profile and at least one user profile for at least one of a user of the first communication device and at least a second user of the at least a second communication device. A transmission element [130] transmits the relevant content to at least one of the first communication device, the at least a second communication device, and a predetermined multimedia device [145].

### TECHNICAL FIELD

This invention relates generally to conversation analysis systems.

### BACKGROUND

Many people frequently participate in telephone calls, and/or videoconference calls, involving a variety of subjects. Sometimes it is known beforehand that a certain subject matter is going to be discussed in the phone call. For example, in a business setting, it may be known prior to the call that the director of marketing is going to discuss marketing strategies with an executive at the company. In this example, the director of marketing may want to discuss a marketing strategy or other topic for which it would be helpful to have a visual aid to show to the executive during the conversation. According to many current systems, the director would have to email to the executive the visual aid before or during the conversation. Such a process can be cumbersome, however, and it is possible that the visual aid might not be received soon enough or that the director or executive may have to search for a location of the visual aid on a computer during the conversation, resulting in wasted time and effort.

There are current systems in the art that provide advertising to a user based on certain information. For example, a person viewing a website may have manually filled out a profile when signing up for access to that webpage, such as an online news service website. Accordingly, whenever the user comes back to the website, advertising is generated for the user based on the user's profile. Other systems in the art generate or modify a user's profile based on the type of items that the user has purchased from the website in the past. For example, if the user has purchased two action digital video discs (DVD) movies from an online website, the user's profile may be modified to generate and display advertisements corresponding to this shopping preference so that the next time the user clicks on that website, advertising for action movies similar to the ones already purchased will be displayed to the user. Both of these systems are deficient, however, because the user has to either manually answer questions, make certain transactions, or click on certain items in order to generate a profile to steer the types of advertisements displayed to the user.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a system according to at least one embodiment of the invention;

FIG. 2 illustrates a lookup table according to at least one embodiment of the invention;

FIG. 3 illustrates the intelligent communication agent according to at least one embodiment of the invention;

FIG. 4 illustrates a method of providing multimedia content upon the occurrence of certain keywords according to at least one embodiment of the invention; and

FIG. 5 illustrates a system according to at least one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

Generally speaking, pursuant to these various embodiments, a method and system is provided for monitoring a conversation for the occurrence of certain keywords. The conversation may be an audible conversation, such as one between two or more people using mobile stations (such as cellular telephones), hard-wired telephones, or any other type of communications device capable of transmitting and receiving voice data. Alternatively, the conversation may be a text-based conversation, such as an Instant Messaging conversation. In some embodiments, the conversation is analyzed substantially in real-time. In other embodiments, the conversation is stored after it has ended and is subsequently analyzed.

As used herein, “keywords” can refer to an individual word, a portion of a word, and/or a combination of words in a particular order or grouping. The keywords may be automatically determined based on repeated sound bites or stressed sound bites that are detected within the conversation. Alternatively, certain keywords may already be known before the conversation takes place. For example, it may be known that that the words “2005 marketing presentation,” or “CDMA-2000” are keywords. The keywords may be automatically determined based on analysis of previous conversations or the previous use of certain documents by a participant in the conversation. By analyzing conversations, important keywords may be determined and a prediction may be made as to whether those keywords are likely to be used again in future conversations. Alternatively, a given user may manually select appropriate keywords prior to engaging in the conversation.

An intelligent communication agent may “listen” to the conversation to detect an occurrence of the keywords. The intelligent communication agent may be a software module that analyzes the audio or text-based communication for occurrences of the keywords. For example, the intelligent communications agent may be implemented within a communications device utilized by one of the participants of the conversation. In the event that the user is utilizing a cellular telephone, the intelligent communication agent may be included in that user's cellular telephone. Alternatively, the communication devices for each participant may include their own intelligent communications device. Also, in the event that the user has both a cellular telephone and a Personal Digital Assistant (PDA), and the cellular telephone is in communication with a wireless network via normal wireless methods, the cellular telephone may also be in communication with the PDA via, for example, a hard-wired direct connection or a short-range wireless transmission method such as Bluetooth™.

If desired, the intelligent communication agent may be remotely located and may analyze the audio and/or text of the conversation. For example, the intelligent communication agent may be in direct communication with the wireless network, or some other network or the Internet, to monitor, in whole or in part, the conversation.

The intelligent communication agent may be selectively initiated. For example, the user may be required to manually press a button or enter an instruction to launch the intelligent communication agent to start monitoring a conversation. Alternatively, the intelligent communication agent may automatically launch itself. For example, if it is known that workers have to finish a time-sensitive project, the intelligent communications device may automatically launch itself during conversations taking place near the time deadline.

The intelligent communication agent may be in communication with a database. The database may be local to the intelligent communication agent. For example, in the event that the intelligent communication agent is implemented by a software module of a PDA, the database may be stored in a memory of the PDA. Alternatively, a hard-wired connection may exist between the intelligent communication agent and the database. In at least one other approach, the intelligent communication agent is in communication with the database via a wireless connection and/or via a network such as the Internet.

The database may include multimedia such as various documents corresponding to keywords. For example, the database may include marketing charts corresponding to the keywords “2005 marketing presentation,” or visual documents of standards or other definitions or diagrams corresponding to the keywords “CDMA-2000.” In the event the conversation is in a non-business setting and is between two baseball enthusiasts, documents showing career statistics for former baseball player Babe Ruth may correspond to the keywords “Babe Ruth.” Alternatively, an audio or video file may be associated with certain keywords. For example, upon detecting the keywords “Babe Ruth,” a video or audio of Babe Ruth may be displayed on the PDA or on some other video screen accessible to at least one participant in the conversation. Moreover, the database may also store text files, such as e-mails, associated with keywords.

Alternatively, the intelligent communication agent may be in communication with the Internet or some other network. Upon detecting keywords within a monitored conversation, the intelligent communication agent may search the Internet or other network for multimedia documents or files corresponding to the keyword.

Upon detecting the keywords, the corresponding documents and/or audio or video files are retrieved from the database, Internet, or other network by the intelligent communication agent. A logic engine is in communication with the intelligent communication agent. Alternatively, the logic engine may be included within the intelligent communication agent. The logic engine determines relevance for the multimedia content based on a conversation profile or a user profile for one of the users of the communications devices facilitating the conversation. The user profile may be determined based on previous conversations for the user and/or manual entries by the user. The conversation profile is determined based on an analysis of the conversation. For example, if certain keywords are located a substantial number of times within a monitored conversation, the logic engine may determine those keywords to be more important than other keywords that occur less often.

The retrieved multimedia content is either displayed or opened for at least one, or all, of the parties to the conversation. This implementation therefore provides functionality to enhance interpersonal communication by performing the search effort for certain documents or media prior to a conversation participant making a manual request to view or hear the appropriate documents or media. So configured, the intelligent communication agent can effectively make predictions of need for certain data and gather data based on certain keywords, and the logic engine determines the most relevant content to provide to the user.

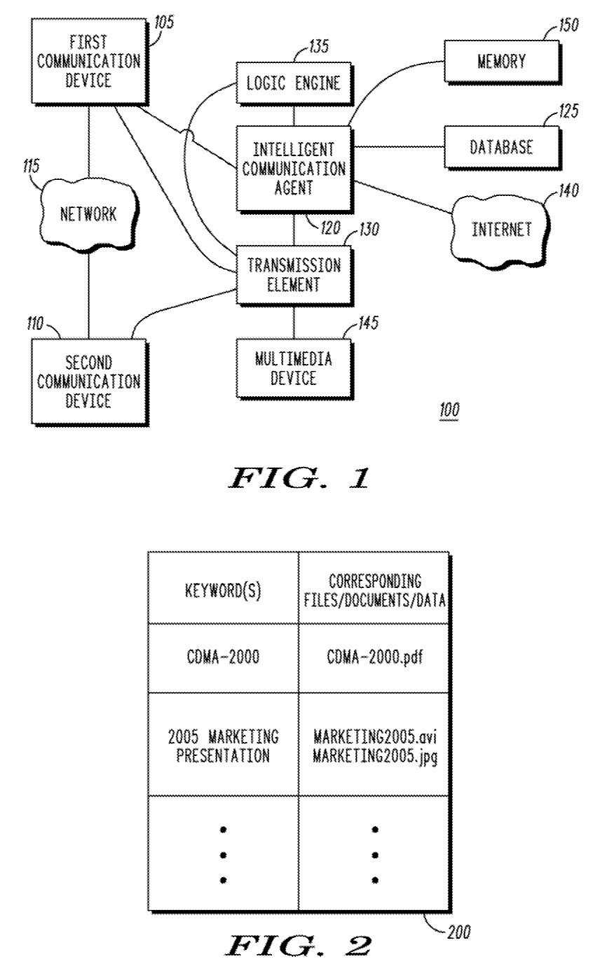

FIG. 1 illustrates a system 100 according to at least one embodiment of the invention. As shown, the system 100 includes a first communication device 105, a second communication device 110, a network 115, an intelligent communication agent 120, a database 125, a transmission element 130, a logic engine 135, the Internet 140, and a multimedia device 145. As discussed above, either or both of the first communication device 105 and the second communications device 110 may comprise a telephone, a mobile communications device (such as a cellular telephone), a PDA, a mobile communications device in communication with a PDA, a computer, or any other suitable electronic device. The first communication device 105 and the second communication device 110 may each comprise any type of communications device capable or transmitting and receiving audio and/or text as part of a conversation.

The first communication device 105 may be in communication with the second communication device 110 via a network 115. The network 115 may comprise a Local Area Network (LAN), a Wide Area Network (WAN), the Internet, or any other type of network for transporting audio and/or text. In an alternative embodiment, the first communication device 105 is in direct communication with the second communication device 110, in which case the network 115 may not be necessary.

As shown, the intelligent communication agent 120 is in communication with the first communication device 105 to monitor the audio and/or text being transmitted back and forth between the first communication device 105 and the second communication device 110 as part of a conversation. Although only shown as being in communication with the first communication device 105, it should be appreciated that the intelligent communication agent 120 could instead be in communication with only the second communication device 110. Alternatively, the intelligent communication agent may be in communication with both the first communication device 105 and the second communication device 110.

The intelligent communication agent 120 is in communication with the database 125 and the Internet 140. The intelligent communication agent 120 monitors the conversation between the first communication device 105 and the second communication device 110 for certain keywords, as discussed above. When keywords are detected, the intelligent communication agent 120 performs a search of the database 125 and/or the Internet 140 or another network (not shown) to locate multimedia content such as audio, video, and/or visual documents or data associated with those keywords. Alternatively, the intelligent communication agent 120 may refer to lookup table stored within a memory 150 to map detected keywords with predetermined multimedia content.

When the keywords are detected, the intelligent communication agent 120 retrieves the corresponding audio, video, and/or visual documents or data from the database 125 and/or the Internet 140. After being retrieved, the logic engine 135 determines relevance for the multimedia content based on a conversation profile or a user profile for one of the users of the communications devices facilitating the conversation. The user profile may be determined based on previous conversations for the user and/or manual entries by the user. The conversation profile is determined based on an analysis of the conversation. For example, if certain keywords are located a substantial number of times within a monitored conversation, the logic engine 135 may determine those keywords to be more important than other keywords that occur less often.

A transmission element 130 is within or controlled by the intelligent communication agent 120. The transmission element 130 sends the relevant retrieved multimedia content to the first communication device 105, the second communication device 110, and/or the multimedia device 145 such as, for example, a television, computer monitor, or projection screen. Upon delivery, the users can view the transmitted multimedia content.

Accordingly, the intelligent communication agent 120 serves to enhance a conversation by determining the identities of information and media corresponding to certain keywords and retrieving and presenting this related information upon detection of the associated keywords.

In the event that a keyword string is detected such as “Jun. 14, 2006 meeting,” the intelligent communication agent 120 may search the database 125 for associated multimedia content. In the event that, for example, five e-mail communications relate to the Jun. 14, 2006 keyword string, all five e-mails are retrieved and may then be presented to one or more of the participants in the conversation. This serves to enhance the conversation because such multimedia content is automatically retrieved, and the conversation participants would therefore not have to each manually search for the associated e-mails themselves.

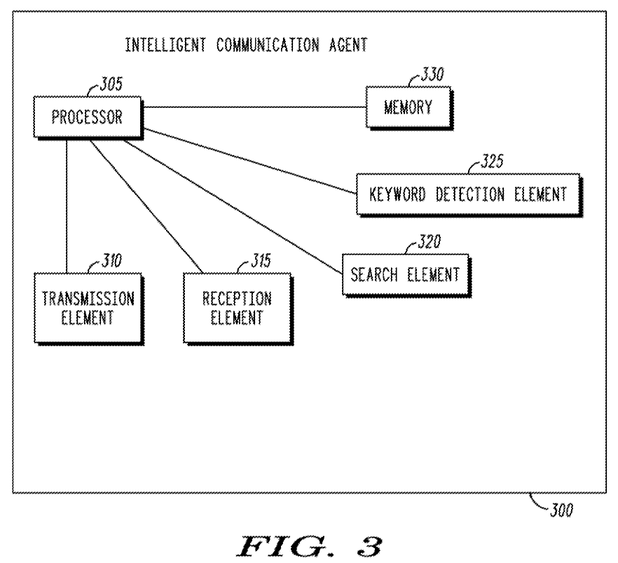

FIG. 2 illustrates a lookup table 200 according to at least one embodiment of the invention. The lookup table 200 may be stored within the memory 150 accessible by the intelligent communication agent 120 as illustrated in FIG. 1. As shown, the lookup table 200 includes mapping of certain keyword(s) to corresponding files/documents/data. The keywords(s) “CDMA-2000” are mapped to the corresponding file entitled “CDMA-2000.pdf.” Similarly, the keywords “2005 Marketing Presentation” are mapped to the corresponding video file “Marketing2005.AVI” and the image file “Marketing2005.JPG.” Accordingly, when either of these keywords are detected, the intelligent communications agent may refer to the lookup table 200 to determine the correspond files/documents/data to be retrieved. Although only one file is shown as corresponding to, for example, “CDMA-2000,” it should be appreciated that a plurality of files/documents/data may be mapped to “CDMA-2000” or any of the keywords. Also, although only two sets of keywords are displayed, it should be appreciated that more or fewer than two sets of keywords may be utilized, depending on the relevant application.

FIG. 3 illustrates an intelligent communication agent 300 according to at least one embodiment of the invention. As shown, the intelligent communication agent 300 includes a processor 305, a transmission element 310, a reception element 315, a search element 320, a keyword detection element 325, and a memory 330. In some embodiments, a single transceiver may be utilized instead of a separate transmission element 310 and reception element 315. The transmission element 310 and the reception element 315 are in communication with the first communication device 105 and/or the second communication device 110 shown in FIG. 1 or with some other device in the chain of the communication links between the first communication device 105 and the second communication device 110.

The reception element 315 acquires the audio and/or text data transmitted during the conversation and the processor 305 analyzes the audio and/or text for the presence of the keywords. The keywords may be individual words, portions of words, and/or a combination of words in a particular order or grouping. The keywords may be automatically determined based on repeated sound bites or stressed sound bites that are detected within the conversation. For example, during the conversation one of the speakers may utilize a different pitch, tone, or volume level when speaking certain words that are critical to the conversation.

The speakers may also repeat certain words throughout the conversation that are important to the conversation. For example, if the words “CDMA-2000” are repeated 15 times, for example, during a three-minute conversation, it may be inferred that CDMA-2000 is a keyword based on this higher than normal repetition.

Alternatively, certain keywords may already be known before the conversation takes place. For example, it may be known that that the words “2005 marketing presentation,” or “CDMA-2000” are keywords.

The memory 330 may hold program code to be executed by the processor 305. The memory 330 may also include the lookup table 200 discussed above with respect to FIG. 2, although in some embodiments the memory in which the lookup table 200 is stored is separate from the intelligent communication agent 300 as shown in FIG. 1, where memory 150 is separate from intelligent communication agent 120. When analyzing the conversation, the keyword detection element 325 detects the keywords.

When keywords are detected, the search element 320 is instructed or controlled by the processor 305 to perform a search for information pertaining to the keywords. The search element 320 may perform a search of the database 125 or the Internet 140 shown in FIG. 1 or some other accessible network. Upon locating associated multimedia content such as documents or files, such multimedia content is retrieved and then transmitted by the transmission element 310 to the logic engine 135, as shown in FIG. 1.

The logic engine 135 determines relevance for the multimedia content based on a conversation profile or a user profile for one of the users of the communications devices facilitating the conversation. The user profile may be determined based on previous conversations for the user and/or manual entries by the user. The conversation profile is determined based on an analysis of the conversation. For example, if certain keywords are located a substantial number of times within a monitored conversation, the logic engine 135 may determine those keywords to be more important than other keywords that occur less often.

Although it is described above that the intelligent communication agent 120 retrieves multimedia content and then the logic engine 135 determines the relevance of the multimedia content, it should be appreciated that in some embodiments the intelligent communication agent 120 initially retrieves only a link to the located multimedia content. In such embodiments, the logic engine 135 determines the relevance of the multimedia content based on the link and associated information and then informs the intelligent communication agent 120 as to the most relevant multimedia content. Finally, the intelligent communication agent 120 would retrieve the actual multimedia content based on the input from the logic engine 135.

After the most relevant multimedia content has been retrieved, such content is sent to the transmission element 130 shown in FIG. 1. The transmission element 130 may transmit the relevant multimedia content to any or all of the first communication device 105, the second communication device 110, additional communication device(s) (not shown), and the multimedia device 145. Upon delivery, the conversation participants can view or listen to the retrieved multimedia content.

The intelligent communication agent 300 shown in FIG. 3 is a physical, i.e., tangible, entity. It should be appreciated, however, that a software module could instead implement the intelligent communication agent 300 implemented by, for example, a processor within a user's cell phone or PDA.

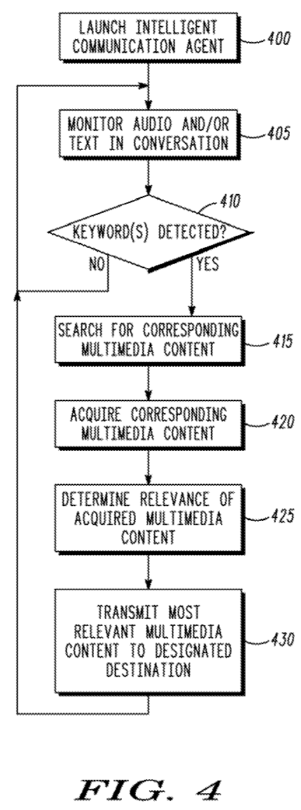

FIG. 4 illustrates a method of providing multimedia content upon the occurrence of certain keywords according to at least one embodiment of the invention. First, at operation 400, the intelligent communication agent 120 is launched. Next, at operation 405, the intelligent communication agent 120 monitors the audio and/or text in the conversation. At operation 410, a determination is made as to whether any of the keywords are detected. If “no,” processing returns to operation 405. If “yes,” on the other hand, processing proceeds to operation 415. This determination of whether keywords are detected may be made by analyzing the conversation for repeated sound bites or stressed sound bites as discussed above with respect to FIG. 3. Alternatively, the keywords may be detected via reference to the lookup table 200 discussed above with respect to FIG. 2.

Next, at operation 415, the intelligent communication agent 120 searches for multimedia content corresponding to the detected keywords. As discussed above, this search may be performed on the database 125, the Internet 140, and/or some other accessible network. Upon locating the corresponding multimedia content, the multimedia content is acquired at operation 420. Next, a relevance of the acquired multimedia content is determined at operation 425 by the logic engine 135 shown in FIG. 1. As discussed above with respect to FIG. 3, the logic engine 135 determines relevance for the multimedia content based on a conversation profile or a user profile for one of the users of the communications devices facilitating the conversation. The user profile may be determined based on previous conversations for the user and/or manual entries by the user. The conversation profile is determined based on an analysis of the conversation.

The keywords may be determined based on analysis of previous conversations and/or documents used by one or more persons in a predetermined group known to have conversations of a particular nature, such as those relating to a business. The keywords may also be selected by a computer program designed to determine keywords based on known characteristics about the user. For example, if it is known that the user is an avid baseball fan, keywords relating to baseball, such as the words/terms “home run,” “double,” “ballpark,” “first baseman,” and so forth may be selected as keywords for the user.

Finally, at operation 430, the most relevant multimedia content is transmitted to a designated destination, such as the first communication device 105, the second communication device 110, or the multimedia device 145 where such multimedia content is viewed or played. Alternatively, the multimedia content is transmitted but not immediately displayed until the conversation participant(s) takes some action such as pressing a certain button on their communications device or entering some kind of instruction to display the files/documents/data.

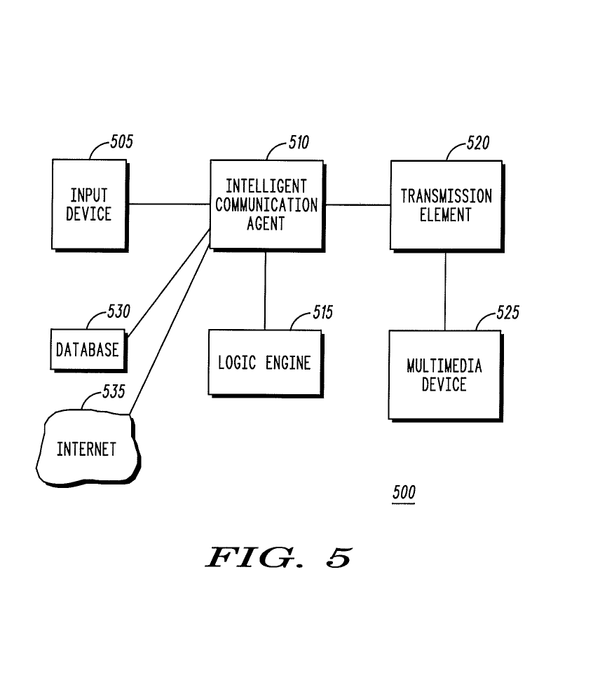

FIG. 5 illustrates a system 500 according to at least one embodiment of the invention. As shown, the system 500 includes an input device 505, intelligent communication agent 510, logic engine 515, transmission element 520, multimedia device 525, database 530, and the Internet 535. The embodiment shown in FIG. 5 differs from shown in FIGS. 1-4 in that instead of monitoring an active conversation, a user may instead manually provide keywords to the input device 505.

As shown, the intelligent communication agent 510 is in communication with the input device 505 and receives the keywords from the input device 505. The intelligent communication agent 510 is in communication with the database 530 and the Internet 535. When keywords are received from the input device 505, the intelligent communication agent 510 performs a search of the database 530 and/or the Internet 535 or another network (not shown) to locate audio, video, and/or visual documents or data associated with those keywords. Alternatively, the intelligent communication agent 510 may refer to lookup table stored within a memory (not shown) to map detected keywords with the identity of certain audio, video, and/or visual documents or data.

When the corresponding multimedia content is located in the database 530 or on the Internet 535, the intelligent communication agent 510 retrieves the corresponding multimedia content. After being retrieved, the logic engine 515 determines relevance for the multimedia content based on a user profile for the user. The user profile may be determined based on previous entries for the user and/or a user profile manually entered by the user.

A transmission element 520 is within or controlled by the intelligent communication agent 510. The transmission element 520 sends the relevant retrieved multimedia content to the multimedia device 525 which may be, for example, a television, computer monitor, or projection screen. Upon delivery, the users can view the transmitted multimedia content.

So configured, those skilled in the art will recognize and appreciate that a conversation between two or more participants can be greatly enhanced through ready availability of supplemental materials that are likely relevant to the discussion at hand. These teachings are highly flexible and can be implemented in conjunction with any of a wide variety of implementing platforms and application settings. These teachings are also highly scalable and can be readily utilized with almost any number of participants.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one example in this regard, these teachings will readily accommodate using speaker identification techniques to identify a particular person who speaks a particular keyword of interest. In such a case, the follow-on look-up activities can be directed to (or limited to) particular content as has been previously related to that particular person. In this case, the retrieved content would be of particular relevance to the keyword speaker. As another example in this regard, a given participant can be given the ability to disable this feature during the course of a conversation if that should be their desire.

We claim:

1. A system, comprising:
a first communication device to participate in a conversation with at least a second communication device;
an intelligent communication agent to monitor the conversation for at least one keyword, wherein in response to detecting the at least one keyword, the intelligent communication agent performs a search for multimedia content corresponding to the at least one keyword and retrieves the multimedia content;
a logic engine to determine relevant content of the multimedia content based on at least one of a conversation profile and at least one user profile for at least one of a user of the first communication device and at least a second user of the at least a second communication device; and
a transmission element to transmit the relevant content to at least one of the first communication device, the at least a second communication device, and a predetermined multimedia device.

2. The system of claim 1, wherein in the intelligent communication agent comprises a keyword detection element to detect the at least one keyword based on a detection of at least one of repeated sound bites and stressed sound bites.

3. The system of claim 1, wherein the intelligent communication agent comprises a search element to search at least one of a database and the Internet.

4. The system of claim 1, wherein the intelligent communication agent is adapted to utilize a lookup table to determine an identity of the at least one multimedia item corresponding to the at least one keyword.

5. The system of claim 1, wherein the first communication device is in communication with the at least a second communication device via at least one of a hard-wired connection, a network, and the Internet.

6. The system of claim 1, wherein the at least one user profile is determined based on at least one of previous conversations for the user and manual entries by the user.

7. The system of claim 1, wherein the conversation profile is determined based on an analysis of the conversation.

8. The system of claim 1, wherein the conversation comprises at least one of audio and text.

9. The system of claim 1, wherein the at least one multimedia item comprises at least one of a document, text content, audio content, and video content.

10. The system of claim 1, further comprising a memory to store the conversation, wherein the intelligent communication device monitors the conversation after the conversation has ended and has been stored in the memory.

11. A method, comprising:
communicating, by a first communication device, with at least a second communication device;
monitoring the communicating for at least one keyword;
performing a search for multimedia content corresponding to the at least one keyword;
retrieving the multimedia content;
determining relevant content of the multimedia content based at least one of a conversation profile and at least one user profile for at least one of a user of the first communication device and at least a second user of the at least a second communication device; and
transmitting the relevant content to at least one of the first communication device, the at least a second communication device, and a predetermined multimedia device.

12. The method of claim 11, further comprising detecting the at least one keyword based on a detection of at least one of repeated sound bites and stressed sound bites.

13. The method of claim 11, further comprising searching at least one of a database and the Internet.

14. The method of claim 11, further comprising utilizing a lookup table to determine an identity of the at least one file corresponding to the predetermine keywords.

15. The method of claim 11, wherein the communication is via at least one of a hard-wired connection, a network, and the Internet.

16. The method of claim 11, further comprising determining the at least one user profile based on at least one of previous conversations for the user and manual entries by the user.

17. A system, comprising:
an input device to receive, from at least one user, at least one manually entered keyword;
an intelligent communication agent to perform a search for multimedia content corresponding to the at least one keyword and retrieve the multimedia content;
a logic engine to determine relevant content of the multimedia content based on at least one user profile for the at least one user; and
a transmission element to transmit the relevant content to a predetermined multimedia device.

18. The system of claim 17, further comprising a memory to store a lookup table mapping the at least one keyword with the at least one multimedia item.

19. The system of claim 17, wherein the at least one multimedia item comprises at least one of a document, text content, audio content, and video content.

20. The system of claim 17, wherein the intelligent communication agent comprises a search element to search at least one of a database and the Internet.
